(19) United States
(12) Patent Application Publication
(10) Pub. No.: US 2016/0202375 A1
(43) Pub. Date: Jul. 14, 2016

(54) Eikonal Solver for Quasi P-Waves in Anisotropic Media

(71) Applicant: WESTERNGECO LLC, Houston, TX (US)

(72) Inventors: Umair Bin Waheed, Kaust (SA); Can Evren Yarman, Houston, TX (US); Garret Flagg, Houston, TX (US)

(21) Appl. No.: 15/023,628

(22) PCT Filed: Sep. 19, 2014
(86) PCT No.: PCT/US2014/056539

§ 371 Date: Mar. 21, 2016

Related U.S. Application Data
(60) Provisional application No. 61/880,265, filed on Sep. 20, 2013.

(51) Int. Cl. G01V 1/30

(52) U.S. Cl. CPC G01V 1/305; G01V 2210/586; G01V 2210/675

(57) ABSTRACT

Computing systems, computer-readable media, and methods for calculating traveltime in a model. The method includes receiving a model of a subterranean domain including an anisotropic media, with the model including a grid having gridpoints representing locations in the domain and a source location. The method also includes defining an eikonal equation for calculating a traveltime from the source location, through the anisotropic media, to at least one of the gridpoints, and separating the eikonal equation into a first equation and a second equation. The method further includes iteratively solving the first equation using a processor, such that a first traveltime solution is determined, and numerically evaluating the second equation based on the first traveltime solution.

### CROSS-REFERENCE TO RELATED APPLICATIONS

This application claims priority to U.S. Provisional Patent Application Ser. No. 61/880,265, which was filed on Sep. 20, 2013. The entirety of this provisional application is incorporated herein by reference.

### BACKGROUND

Many seismic processing and interpretation applications include computing traveltime, e.g., the time between when a seismic wave leaves a source to when it arrives at a certain location. Such applications include Kirchoff modeling and migration algorithms, velocity-estimation algorithms, such as first arrival tomography, reflection tomography, etc. Further, prestack depth migration may emphasize incorporation anisotropy into seismic processing workflow, including traveltime analysis, as the process may be sensitive to accuracy in the velocity field.

In such applications, numerical solutions to anisotropic wave traveltime equations (e.g., eikonal equations) may be calculated. Complex anisotropies, such as tilted axis, orthorhombic symmetry (TOR) anisotropy may provide more accurate models of some subterranean domains, in comparison to elliptically anisotropic models. However, the wave equations representing traveltimes in these complex anisotropies may be higher-order, non-linear, partial differential equations, and thus solving these equations numerically may be challenging and costly from a computation time standpoint.

There is a need, therefore, for systems and methods for efficiently calculating traveltime in subterranean domains with complex anisotropy.

### SUMMARY

Embodiments of the present disclosure may provide a method for calculating traveltime in a model. The method includes receiving a model of a subterranean domain including an anisotropic media, with the model including a grid having gridpoints representing locations in the domain and a source location. The method also includes defining an eikonal equation for calculating a traveltime from the source location, through the anisotropic media, to at least one of the gridpoints, and separating the eikonal equation into a first equation and a second equation. The method further includes iteratively solving the first equation using a processor, such that a first traveltime solution is determined, and numerically evaluating the second equation based on the first traveltime solution.

In an embodiment, separating the eikonal equation into a first equation and a second equation includes setting a side of the first equation equal to an intermediate term and setting a side of the second equation equal to the intermediate term.

In an embodiment, the method further includes assigning an initial value to the intermediate term prior to iteratively solving the first equation.

In an embodiment, numerically evaluating the second equation includes determining a first calculated value for the intermediate term.

In an embodiment, the method further includes iteratively solving the first equation based on the first calculated value of the intermediate term, such that a second traveltime solution is determined, with the second traveltime solution being different from the first traveltime solution.

In an embodiment, the method further includes numerically evaluating the second equation based on the second traveltime solution, such that a second calculated value of the intermediate term is determined.

In an embodiment, iteratively solving the first equation and numerically evaluating the second equation are performed in a first iteration. In such an embodiment, the method may further include performing one or more additional iterations, including iteratively solving the first equation an additional time, based on a calculated value for the intermediate term calculated in a previous iteration, such that a new traveltime solution is determined, and numerically evaluating the second equation an additional time, such that a new calculated value for the intermediate term is determined based on the new traveltime.

In an embodiment, the method further includes extrapolating a convergence value for the traveltime solution based on the traveltime solution determined in the first iteration, the new traveltime solution determined in at least one of the one or more additional iterations, or a combination thereof.

In an embodiment, iteratively solving the first equation includes selecting a gridpoint of the grid, determining a number of directions from the gridpoint in which one or more neighbors have a calculated traveltime value, and when the number of directions is at least one, calculating a traveltime solution for the gridpoint based on the first equation and the traveltimes for the one or more neighboring gridpoints.

In an embodiment, iteratively solving the first equation further includes determining a causality of the traveltime solution for the gridpoint, at least when the number of directions is at least two.

In an embodiment, iteratively solving the first equation includes assigning an initial traveltime value to a source location, such that the source location includes a grid point having a calculated traveltime.

In an embodiment, the eikonal equation represents traveltimes in media having an anisotropy selected from the group consisting of: tilted axis, orthorhombic; tilted axis, transverse, monoclinic, and triclinic.

In an embodiment, the method also includes updating the model using the traveltime solution, and displaying a location of a wave in the model at one or more times after the source emits or reflects the wave.

Embodiments of the disclosure may also provide a non-transitory computer-readable medium storing instructions that, when executed by at least one processor of a computing system, cause the computing system to perform operations. The operations include receiving a model of a subterranean domain including an anisotropic media, with the model including a grid having gridpoints representing locations in the domain and a source location. The operations also include defining an eikonal equation for calculating a traveltime from the source location, through the anisotropic media, to at least one of the gridpoints, and separating the eikonal equation into a first equation and a second equation. The operations also include iteratively solving the first equation such that a first traveltime solution is determined, and numerically evaluating the second equation based on the first traveltime solution.

Embodiments of the present disclosure may further provide a computing system. The computing system includes one or more processors, and a memory system including a non-transitory computer-readable medium storing instructions that, when executed by at least one of the one or more processors, cause the computing system to perform operations. The operations include receiving a model of a subterranean domain including an anisotropic media, with the model including a grid having gridpoints representing locations in the domain and a source location. The operations also include defining an eikonal equation for calculating a traveltime from the source location, through the anisotropic media, to at least one of the gridpoints, and separating the eikonal equation into a first equation and a second equation. The operations also include iteratively solving the first equation such that a first traveltime solution is determined, and numerically evaluating the second equation based on the first traveltime solution.

Embodiments of the disclosure may also provide computer-readable storage medium is provided, the medium having a set of one or more programs including instructions that when executed by a computing system cause the computing system to receive a model of a subterranean domain including an anisotropic media, with the model including a grid having gridpoints representing locations in the domain and a source location. The instructions also cause the computing system to define an eikonal equation for calculating a traveltime from the source location, through the anisotropic media, to at least one of the gridpoints, and to separate the eikonal equation into a first equation and a second equation. The instructions further cause the computing system to iteratively solve the first equation, such that a first traveltime solution is determined, and numerically evaluate the second equation based on the first traveltime solution.

Embodiments of the disclosure may further provide a computing system that includes at least one processor, at least one memory, and one or more programs stored in the at least one memory. The computing system further includes means for receiving a model of a subterranean domain including an anisotropic media, with the model including a grid having gridpoints representing locations in the domain and a source location. The computing system also includes means for defining an eikonal equation for calculating a traveltime from the source location, through the anisotropic media, to at least one of the gridpoints, and means for separating the eikonal equation into a first equation and a second equation. The computing system further includes means for iteratively solving the first equation using a processor, such that a first traveltime solution is determined, and means for numerically evaluating the second equation based on the first traveltime solution.

Thus, the computing systems and methods disclosed herein are more effective methods for processing collected data that may, for example, correspond to a subsurface region. These computing systems and methods increase data processing effectiveness, efficiency, and accuracy. Such methods and computing systems may complement or replace conventional methods for processing collected data. This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a flowchart of a method for calculating traveltime in a model, according to an embodiment.

FIG. 2 illustrates a wave-front at a time in a model, according to an embodiment.

FIG. 3 illustrates a flowchart of a method for calculating traveltime in a model, according to an embodiment.

FIGS. 4 and 5 illustrate flowcharts of a sweeping method for calculating traveltime in a model, according to some embodiments.

FIGS. 6A-6D illustrate another flowchart of a method for calculating traveltime in a model, according to an embodiment.

FIG. 7 illustrates a schematic view of a computing system, according to an embodiment.

### DESCRIPTION OF EMBODIMENTS

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both, objects or steps, respectively, but they are not to be considered the same object or step.

The terminology used in the description of the invention herein is for the purpose of describing particular embodiments only and is not intended to be limiting of the invention. As used in the description of the invention and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques and workflows that are in accordance with some embodiments. Some operations in the processing procedures, methods, techniques and workflows disclosed herein may be combined and/or the order of some operations may be changed.

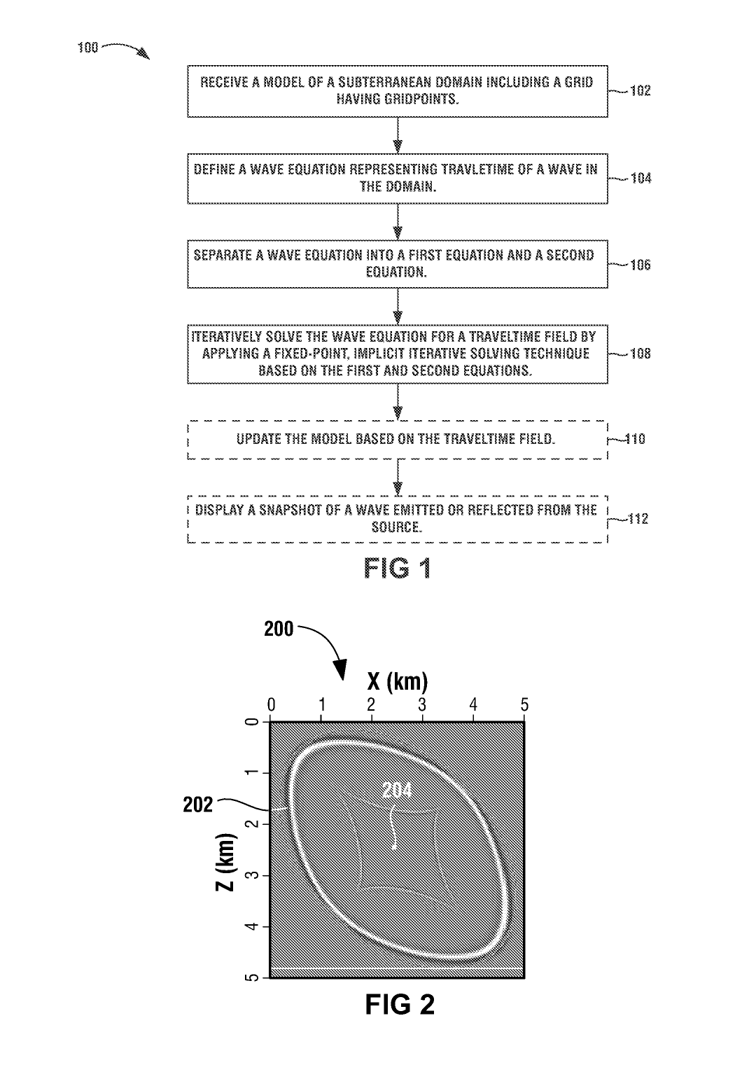

FIG. 1 illustrates a flowchart of a method 100 for solving for traveltime in a model, according to an embodiment. The method 100 may begin by receiving a model of a subterranean domain, as at 102. The model may include a grid of gridpoints representing discrete locations in the subterranean domain. The subterranean domain may include an anisotropic media. Further, the model may include a representation of a seismic source, which may be represented as a point in the grid. The seismic source may be located at the surface of the Earth, or may be a subterranean reflector, such as at an interface between two stratigraphic layers.

The method 100 may also include defining a wave equation representing traveltime of a wave in the domain, as at 104. In an embodiment, the media may be transversely anisotropic, with a tilted axis of symmetry (TTI), which may be tilted with respect to vertical. Further, in at least some embodiments, the media may have, or be approximated as having, an anisotropy with an orthorhombic symmetry. In an embodiment, the media may have, or be approximated as having, a tilted axis, orthorhombic symmetry (TOR).

Accordingly, the traveltime to various points of the grid in the model from the source may be calculated based on a wave equation for a TTI or TOR anisotropic media. One type of wave equation is a high-frequency approximation of the Wentzel-Kramers-Brillouin expansion of the wave equation. This may be known as an “eikonal” equation, which may be a class of Hamilton-Jacobi equations.

The method 100 may include solving an eikonal equation of the TTI or TOR anisotropic media for one or more points in the grid, so as to generate a traveltime field. To do so, in at least some embodiments, the method 100 may include separating the wave equation (e.g., the TTI or TOR eikonal equation) into a first equation and a second equation, as at 106. In at least one embodiment, the first equation may include lower-order portions of the eikonal equation, such that the first equation is similar to an equation describing wave traveltimes in a less-complex anisotropy, such as a tilted, elliptically anisotropic (TEA) model. The second equation may include the higher-order portions of the TTI or TOR eikonal equation. The first and second equations may be separated in the eikonal equation algebraically, by moving the two expressions to opposite sides of the equal sign, and then completing the separation into two equations by setting the two expressions equal to a common, intermediate term.

The method 100 may then include iteratively solving the wave (eikonal) equation for a traveltime field, using a fixed-point, implicit iterative solving technique, as at 108. The traveltime field may represent a duration between when a wave is emitted or reflected from the source, and an arrival of the wave at various points in the grid. As indicated at 108, the iterative solving technique may be based on the first and second equations.

For example, the first equation may be solved for the traveltime solution (e.g., a traveltime field), based on a value of the intermediate term. The second equation may be solved for the intermediate term, based on the traveltime solution generated by solving the first equation. These two processes may be repeated until the traveltime solution converges, or may repeat until the traveltime solution value at convergence may be extrapolated. When the traveltime solution converges, or is extrapolated to convergence, the method 100 may provide a traveltime field for the TTI or TOR media, which may provide the location of a wave-front at a given time in the model of the subterranean domain.

In some embodiments, the method 100 may also include updating the model, as at 110, based on the traveltime field, e.g., the traveltime solution calculated at 108. Further, the method 100 may include displaying a snapshot (e.g., of the model at a point in time) showing a location of a wave emitted or reflected from the source, as at 112.

FIG. 2 illustrates an example of a wavefield snapshot of a domain 200 at a certain time, according to an embodiment. The wavefield snapshot may generate a visualization of a wave front location 202 at the time, based on the calculated traveltime from a source 204. The domain 200 is illustrated in two dimensions, showing depth (vertical axis) and one horizontal dimension, but it will be appreciated that the domain 200 may be represented into three or more dimensions. Further, the illustrated wavefield may be generated using a homogenous TTI model, but may also be produced for homogenous TOR models, or any other model.

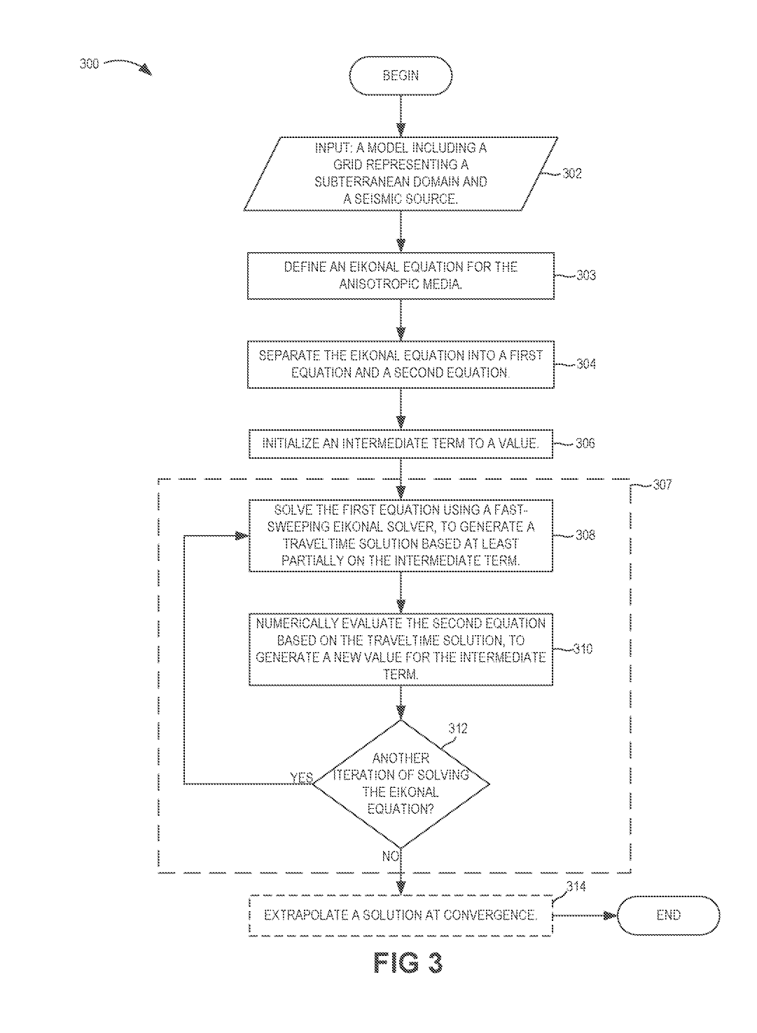

FIG. 3 illustrates a flowchart of a method 300 for solving for traveltime in a model, according to an embodiment. The method 300 may include receiving a model, such as the model 200 of FIG. 2, including a grid representing a subterranean domain and a seismic source (which may be located at a subterranean or surface location), as at 302. The grid may include a plurality of cells, which may define any amount and/or dimension of space in the model, for example, on the order of square meters.

The method 300 may then include defining an eikonal equation, as at 303. The eikonal equation may describe wave traveltimes in a TOR or TTI media. The method 300 may include splitting the eikonal equation into a first equation and a second equation, as at 304. The first equation may include lower-order terms of the TOR or TTI eikonal equation, and may thus be or be similar to an equation that describes wave traveltimes in a tiled axis, elliptically anisotropic (TEA) media. The second eikonal equation may include the higher-order terms, which may be specific to the eikonal equation for wave traveltimes in the TOR or TTI media.

In particular, kinematic signatures of P-waves in orthorhombic media may depend on, for example, five anisotropic parameters and the vertical velocity. The eikonal equation for orthorhombic media, under an acoustic assumption, may be written as:

$${A ( \frac{\partial τ}{\partial x} )}^{2} + {B ( \frac{\partial τ}{\partial y} )}^{2} + {C ( \frac{\partial τ}{\partial z} )}^{2} + {D ( \frac{\partial τ}{\partial x} )}^{2} + {( \frac{\partial τ}{\partial y} )}^{2} + {E ( \frac{\partial τ}{\partial x} )}^{2} + {( \frac{\partial τ}{\partial z} )}^{2} + {F ( \frac{\partial τ}{\partial y} )}^{2} + {( \frac{\partial τ}{\partial z} )}^{2} + {G ( \frac{\partial τ}{\partial x} )}^{2} + {( \frac{\partial τ}{\partial y} )}^{2} + {( \frac{\partial τ}{\partial z} )}^{2} = 1 \qquad ( 1 )$$

where τ(x, y, z) is the traveltime measured from the source to a point with coordinates (x, y, z). Using a parameterization of the orthorhombic media, the coefficients appearing in equation (1) may have the following definitions:

A=v₁²(1+2η₁), B=v₂²(1+2η₂), C=v₀²

D=v₁²(1+η₁)((1+2η₁)γ²v₁²−1+2η₂²)), E=−2η₁v₁²v₀²,

F=−2η₂v₂²v₀², G=−v₀²v₁²((1+2η₁)²−2(1+2η₁)v₁v₂γ+(1−4η₁η₂)v₂²). (2)

where v₀ is the symmetric-axis velocity; v₁ and v₂ are the normal moveout velocities in the x-z and y-z planes, respectively; and ηₕ and η₂ correspond to the an ellipticity anisotropy parameter values in the x-z and y-z planes, respectively. Moreover, the parameter γ is defined in terms of the δ parameter in the x-y plane through the relation, γ=\sqrt{(1+2δ)}.

For TOR media, the traveltime derivatives in equation (1) may be taken with respect to dip angle θ, azimuthal angle φ, and rotation angle ψ. Thus, the traveltime derivatives in equation (1) may be rotated to give:

[symbol]

=(cos φ cos ψ cos θ−sin φ sin ψ)(∂ₓτ)+(cos φ sin ψ+cos ψ sin φ cos θ)(∂_{y}τ)+(cos ψ sin θ)(∂_{z}τ),

[symbol]

=(−cos ψ sin φ−cos φ cos θ sin ψ)(∂ₓτ)+(cos φ cos ψ−cos θ sin φ sin ψ)(∂_{y}τ)−(sin ψ sin θ)(∂_{z}τ),

[symbol]

=−(cos φ sin θ)(∂ₓτ)−(sin φ sin θ)(∂_{y}τ)+(cos θ)(∂_{z}τ), (3)

Hence, the TOR eikonal equation may be given as:

A( [symbol] )²+B( [symbol] )²+C( [symbol] )²+D( [symbol] )²( [symbol] )²+E( [symbol] )²( [symbol] )+F) [symbol] )²( [symbol] )²+G( [symbol] )²( [symbol] )²+( [symbol] )²=1. (4)

where

$$( \frac{\partial x}{} ) , ( \frac{\partial y}{} ) , and ( \frac{\partial z}{} )$$

denote the traveltime derivatives in the rotated coordinate frame given by equation (3), whereas the coefficients A, B, C, D, E, F, and G are defined in equation (2).

The TOR eikonal equation given by equation (4) reduces to a TTI eikonal equation by setting v₁=v₂=vₙₘₒ, η₁=η₂=η, and γ=1. Substituting these relationships into equation (4) yields a three-dimensional TTI eikonal equation:

vₙₘₒ²(1+2η)(( [symbol] )²+( [symbol] )²)+v₀²( [symbol] )²(1−2ηvₙₘₒ²(( [symbol] )²+( [symbol] )²))=1. (5)

### Here,

$$( \frac{\partial x}{} ) , ( \frac{\partial y}{} ) , and ( \frac{\partial z}{} )$$

represent the coordinate transformed traveltime derivatives, as defined by equation (3).

The level of nonlinearity in the eikonal equations (4) and (5) may be higher than that for the isotropic or elliptically anisotropic eikonal equations. This may result in a more complicated finite-difference solution approximation. The nonlinearity in these eikonal equations may produce multiple branches of the solution. Multivalued eikonal solutions may include different times of waves (e.g., direct, reflected, head, etc.) as well as different branches of caustics.

A discretization of equation (5) for a grid node (i, j, k) may be expressed as:

α₄τ_{i,j,k}⁴+α₃τ_{i,j,k}³+α₂τ_{i,j,k}²+α₁τ_{i,j,k}+α₀=0, (6)

where the coefficients αᵢ depend on the physical parameters for the TTI media. A discretization of the TOR eikonal equation (4), results in a polynomial expression for a gridpoint (i, j, k) as:

β₆τ_{i,j,k}⁶+β₅τ_{i,j,k}⁵+β₄τ_{i,j,k}⁴+β₃τ_{i,j,k}³+β₂τ_{i,j,k}²+β₁τ_{i,j,k}+₀=0, (7)

where the set of coefficients Bᵢ depend on the physical parameter values for TOR media. The computational time complexity in solving equations (6) or (7) may be a result of solving for multiple roots at the grid points and then choosing the correct outgoing P-wave solution.

Thus, as at block 304 of FIG. 3, to simplify the process of solving the TOR eikonal equation (4), the method 300 may include separating the TOR eikonal equation (4) into two equations. The first equation, similar to a TEA eikonal equation, may be:

A( [symbol] )²+B( [symbol] )²+C( [symbol] )²=ƒ_{TOR}(τ), (8)

The second equation, for the higher-order terms of the TOR equation, may be:

ƒ_{TOR}(τ)=1−D( [symbol] )²( [symbol] )²−E( [symbol] )²( [symbol] )²−F( [symbol] )²( [symbol] )²−G( [symbol] )²( [symbol] )²( [symbol] )² (9)

The coefficients A, B, C, D, E, F, G, and the traveltime derivatives

$$( \frac{\partial x}{} ) , ( \frac{\partial y}{} ) , and ( \frac{\partial z}{} )$$

may be defined as in equations (2) and (3), respectively.

The eikonal equation, equation (4), may thus be solved numerically using an implicit, fixed-point iteration with the following term, which may be provided by rewriting equation (8) as:

A( [symbol] )²+B( [symbol] )²+C( [symbol] )²=ƒ_{TOR}(τₙ₋₁), (10)

in combination with the second equation, equation (9).

Accordingly, for purposes of description herein, the “first equation” may be equation (10), in an embodiment. Further, the right-hand side of the first equation, equation (10), may be equal to an intermediate term ƒ_{TOR}(τₙ₋₁) The intermediate term may have a fixed value while iteratively solving the first equation. The value for the intermediate term may be generated by numerically evaluating the second equation, equation (9), based on the value of τ established by iteratively solving the first equation. Initially, the second equation may not yet have been solved; therefore, the solution to the second equation, the intermediate term ƒ_{TOR}(τₙ₋₁), (n=1), may be initialized to a predetermined or arbitrary value, as at 306.

Proceeding with the embodiment of the method 300 illustrated in FIG. 3, after separating the eikonal equation (equation (4)) into a first equation (equation (10)) and a second equation (equation (9)), the method 300 may proceed into a loop 307, in which the method 300 may include iteratively solving the eikonal equation (4). In an embodiment, individual iterations of the loop 307 may include iteratively solving the first equation using a “sweeping” technique, such as a fast-sweeping eikonal solver, as at 308. Solving the first equation may generate a traveltime solution τₙ, which may be a traveltime field for the grid. Based on the calculated traveltime solution τₙ, the method 300 may include numerically evaluating the second equation, equation (9), such that a new value for the intermediate term ƒ_{TOR}(τₙ) is generated, as at 310. The combination of solving at 308 and evaluating at 310 may thus provide a traveltime solution to the eikonal equation.

The method 300 may then determine whether another iteration the loop 307, e.g., for solving the eikonal equation, is to be considered, as at 312. For example, the determination at 312 may be made based on whether the traveltime solution τₙ has converged. In some embodiments, convergence may be checked prior to evaluating the second equation for one, some, or all iterations of the loop including blocks 308, 310, and 312.

In an embodiment, at block 312, the method 300 may include determining whether a difference between τₙ and τₙ₋₁ is within a predetermined threshold or by applying another statistical measure that may test for convergence. If the traveltime solution τₙ converges, the method 300 may exit the loop 307 and extract the traveltime solution τₙ, which may provide a traveltime field for points in the grid, and employ the solution in the model.

In another embodiment, the determination 312 may be “NO” prior to convergence, and may be based on whether information sufficient to extrapolate the value of the traveltime solution τₙ is available. In such embodiments, the method 300 may exit the loop 307 and extrapolate the traveltime solution τₙ such as by using Aitken's extrapolation, as at 314. Given three or more successive traveltimes obtained by iteratively solving equations (9) and (10), e.g., τₙ, τₙ₊₁, τₙ₊₂, Aitken's extrapolation formula may be given by:

Aₙ≈τₙ−(τₙ₊₁−τₙ)²(τₙ−2τₙ₊₁+τₙ₊₂)⁻¹ (11)

Aitken's extrapolation formula may result in a series Aₙ, which may be the extrapolated convergence of τₙ and may converge more quickly than the series of traveltimes calculated using equations (9) and (10). Aitken's extrapolation may be applied to the resulting series Aₙ as well as successively to the consequent series to further increase the convergence rate.

For example, in TOR anisotropic media, for which equation (11) may not converge in three iterations, given five terms of the fixed-point iteration (τ₁, τ₂, τ₃, τ₄, τ₅), A₁, A₂, and A₃ may computed by equation (11). The traveltime solution τ may then be estimated by applying equation (11) to A₁, A₂, and A₃:

τ≈A₁−(A₂−A₁)²(A₁−2A₂+A₃)⁻¹ (12)

If the traveltime is found to have converged, or convergence is extrapolated using the Aitken extrapolation, the method 300 may end. Otherwise, the method 300 may proceed to another iteration of the loop 307, returning to block 308, as shown.

Using the same or a similar approach as that described above, the method 400 may be applied to three-dimensional TTI equations. As noted above, the TOR eikonal equation (4) may reduce to the TTI eikonal equation (5) by substituting v₁=v₂=vₙₘₒ, η₁=η₂=η, and γ=1. Reformulating the TTI eikonal equation (5) into two (first and second) equations, yields:

$$\begin{matrix}{v}_{nmo}^{2} ( 1 + 2 η ) ( {( \frac{\partial x}{} )}^{2} + {( \frac{\partial y}{} )}^{2} ) + {{v}_{0}^{2} ( \frac{\partial z}{} )}^{2} = {f}_{TTI} ( τ ) & ( 13 ) \\ {f}_{TTI} ( τ ) = 1 + 2 η {v}_{0}^{2} {{v}_{nmo}^{2} ( \frac{\partial z}{} )}^{2} ( {( \frac{\partial x}{} )}^{2} + {( \frac{\partial y}{} )}^{2} ) & ( 14 )\end{matrix}$$

During the first iteration, ƒ_{TTI}(τ)=1 (or another arbitrary value). At convergence, the right-hand side function ƒ_{TTI}(τ) may be evaluated for the TTI media.

In addition, equation (8) may be rewritten in the form of a Hamiltonian, by defining:

$${p}_{x} = \frac{\partial τ}{\partial x} , {p}_{y} = \frac{\partial τ}{\partial y} , {p}_{z} = \frac{\partial τ}{\partial z} ,$$

where pₓ, p_{y}, and p_{z} represent the slowness vector components along the x-direction, y-direction, and z-direction, respectively. The Hamiltonian form of equation (8) may be:

H(x,y,z,pₓ,p_{y},p_{z})=apₓ²+bpy²+cp_{z}²+2dpₓp_{y}+2epₓp_{z}+2ƒp_{y}p_{z}−ƒ_{TOR}(τ) (15)

where:

a=A(cos φ cos ψ cos θ−sin φ sin ψ)²+B(cos φ sin ψ+cos θ+sin φ cos ψ)²+C(cos φ sin θ)²,

b=A(sin φ cos ψ cos θ+cos φ sin ψ)²+B(−sin φ sin ψ cos θ+cos φ cos ψ)²+C(sin φ sin θ)²,

c=A(cos ψ sin θ)²+B(sin ψ sin θ)²+C(cos θ)²,

d=A(cos φ cos ψ cos θ−sin φ sin ψ)(sin φ cos ψ cos θ+cos φ sin ψ)−B(cos φ sin ψ cos θ+sin φ cos ψ)(−sin φ sin ψ cos θ+cos φ cos ψ)+C(cos φ sin φ sin² θ),

e=A(cos φ cos ψ cos θ−sin φ sin ψ)(cos ψ sin θ)+B(cos φ sin ψ cos θ+sin φ cos ψ)(sin ψ sin θ)−C(cos φ sin θ cos θ),

ƒ=A(sin φ cos ψ cos θ+cos φ sin ψ)(cos ψ sin θ)−B(−sin φ sin ψ cos θ+cos φ cos ψ)(sin ψ sin θ)−C(sin φ sin θ cos θ) (16)

where the coefficients A, B, C, D, E, F, and the angles θ, φ, ψ have the same definition as above, whereas ƒ_{TOR}(τ) may be given by equation (9).

Although embodiments of the method 300 are described for TOR and TTI eikonal equations, it will be appreciated that the eikonal equation defined at 303 may be tailored for calculating traveltimes, e.g., in monoclinic, triclinic or another anisotropic media, in accordance with the present disclosure.

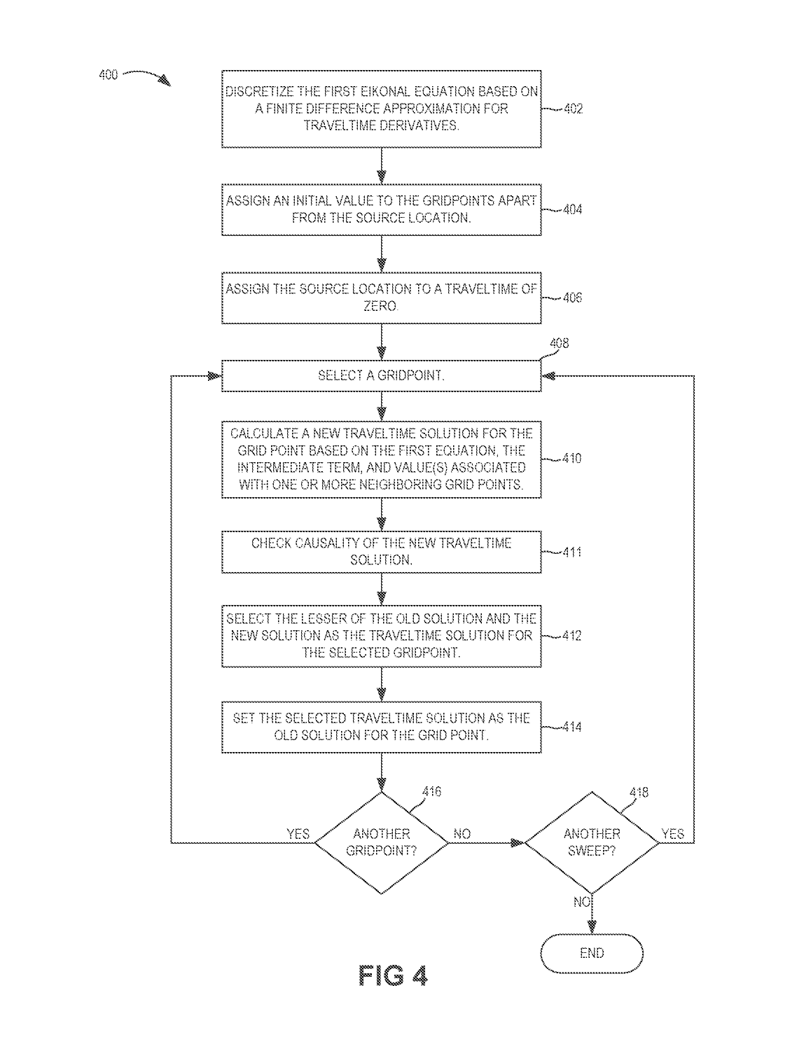

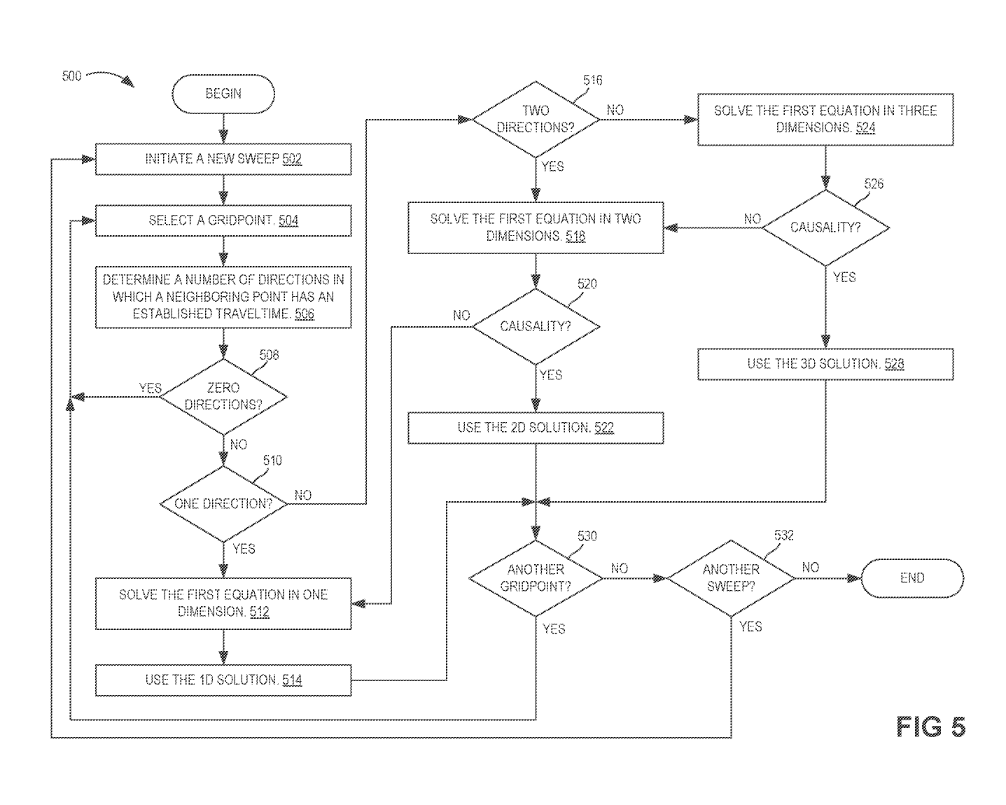

FIG. 4 illustrates a flowchart of a sweeping method 400 for solving for traveltime at gridpoints in a model, according to an embodiment. In some embodiments, the method 400 may be employed as the fast-sweeping eikonal solver for solving the first equation at 308 (FIG. 3).

The method 400 may begin by discretizing the first eikonal equation based on a finite difference approximation for traveltime derivatives, as at 402. To discretize the eikonal equation (8), the finite-difference approximation may be employed, providing:

$$\frac{\partial x}{} = ( cos φ cos ψ cos θ - sin φ sin ψ ) ( \frac{{τ}_{i , j , k} - {τ}_{xmin}}{Δ x} ) {s}_{x} + ( cos φ sin ψ + cos ψ sin φ cos θ ) ( \frac{{τ}_{i , j , k} - {τ}_{ymin}}{Δ y} ) {s}_{y} + ( cos ψ sin θ ) ( \frac{{τ}_{i , j , k} - {τ}_{zmin}}{Δ z} ) {s}_{z} , \\ \frac{\partial y}{} = ( - cos ψ sin φ - cos φ cos θ sin ψ ) ( \frac{{τ}_{i , j , k} - {τ}_{xmin}}{Δ x} ) {s}_{x} + ( cos φ cos ψ - cos θ sin φ sin ψ ) ( \frac{{τ}_{i , j , k} - {τ}_{ymin}}{Δ y} ) {s}_{y} - ( sin ψ sin θ ) ( \frac{{τ}_{i , j , k} - {τ}_{zmin}}{Δ z} ) {s}_{z} , \\ \frac{\partial z}{} = - cos φ sin θ ( \frac{{τ}_{i , j , k} - {τ}_{xmin}}{Δ x} ) {s}_{x} - sin φ sin θ ( \frac{{τ}_{i , j , k} - {τ}_{ymin}}{Δ y} ) {s}_{y} + cos θ ( \frac{{τ}_{i , j , k} - {τ}_{zmin}}{Δ z} ) {s}_{z} , \qquad ( 17 )$$

where
i=2, 3, . . . , I−1, j=2, 3, . . . , J=1, k=2, 3, . . . , K−1.

In such discretization, Δx, Δy, and Δz may denote grid spacing in the x-direction, y-direction, and z-direction, respectively. τ_{i,j,k} may denote the traveltime at the grid point (i, j, k). Further:

$$\begin{matrix}{τ}_{x min} = min ( {τ}_{i - 1 , j , k} , {τ}_{i + 1 , j , k} ) , {τ}_{y min} = min ( {τ}_{i , j - 1 , k} , {τ}_{i , j + 1 , k} ) , \\ {τ}_{z min} = min ( {τ}_{i , j , k - 1} , {τ}_{i , j , k + 1} ) \\ and & ( 18 ) \\ {s}_{x} = \{ \begin{matrix}+ 1 , & if {τ}_{xmin} = {τ}_{i + 1 , j , k} \\ - 1 , & if {τ}_{xmin} = {τ}_{i - 1 , j , k}\end{matrix} , \\ {s}_{y} = \{ \begin{matrix}+ 1 , & if {τ}_{ymin} = {τ}_{i , j + 1 , k} \\ - 1 , & if {τ}_{ymin} = {τ}_{i , j - 1 , k}\end{matrix} , \\ {s}_{z} = \{ \begin{matrix}+ 1 , & if {τ}_{zmin} = {τ}_{i , j , k + 1} \\ - 1 , & if {τ}_{zmin} = {τ}_{i , j , k - 1}\end{matrix} & ( 19 )\end{matrix}$$

The sign variables sₓ, s_{y}, s_{z} may ensure that a consistent discretization is employed. An available neighboring grid point, along with an appropriate sign variable, may be taken for gridpoints on the boundary.

The method 400 may then proceed to assigning an initial value for the traveltime at the gridpoints (i, j, k). In an embodiment, the initial value λ may be assigned to gridpoints apart from the source location gridpoint, as at 404. The value of λ may be different from (e.g., relatively large with respect to) expected traveltimes, such that it is identifiable as representing a gridpoint for which the traveltime has not yet been calculated (e.g., an “unknown” traveltime). The method 400 may also assign a value to the gridpoint representing the source, for example, a traveltime of zero may be associated therewith, as at 406, such that the source gridpoint is associated with a “known” traveltime.

The method 400 may then consider the gridpoints, for example, in turn. Accordingly, the method 400 may include selecting a grid point, as at 408, for which the traveltime may be calculated. The method 400 may then proceed to calculating a new solution τₙ to the first equation (equation (10)), as at 410. For example, the right-hand side of the first equation (equation (9)) may be set to the initial value (n=1) of the intermediate term ƒ_{TOR}(τ₀)=1, as assigned at 404. The calculating at 410 may then calculate the traveltime solution at the gridpoint τ̅ based on the first equation and any previously-calculated traveltimes for neighboring grid points, or based on the initial value of the source point, if the source point is a neighboring point to the selected gridpoint.

The method 400 may also include checking a causality of the new traveltime solution τ̅, as at 411. This causality checking may occur at anytime in the method 400, relative to the other illustrated blocks, after the traveltime solution is calculated. Ensuring causality may mean ensuring the update sequence for the gridpoints is monotone. Accordingly, the updated traveltime value of a gridpoint may be greater than or equal to the neighboring gridpoints that are used to form a finite-difference stencil. The causality condition may be established as:

$$\frac{\partial τ}{\partial x} \cdot \frac{\partial H}{\partial {p}_{x}} + \frac{\partial τ}{\partial y} \cdot \frac{\partial H}{\partial {p}_{y}} + \frac{\partial τ}{\partial z} \cdot \frac{\partial H}{\partial {p}_{z}} \geq 0 \qquad ( 20 )$$

where H(x, y, z, pₓ, p_{y}, p_{z}) represents the Hamiltonian, while pₓ, p_{y}, and p_{z} denote the slowness vectors in the x, y, and z directions, respectively.

The causality condition (equation (20)) may be satisfied when the solution is non-decreasing along the characteristic However, when using a one-sided finite difference approximation, the causality condition may be satisfied when the partial derivatives of traveltime and their corresponding components of the characteristic directions have the same sign, e.g.:

$$\frac{\partial τ}{\partial x} \cdot \frac{\partial H}{\partial {p}_{x}} \geq 0 , \frac{\partial τ}{\partial y} \cdot \frac{\partial H}{\partial {p}_{y}} \geq 0 , \frac{\partial τ}{\partial z} \cdot \frac{\partial H}{\partial {p}_{z}} \geq 0 \qquad ( 21 )$$

The method 400 may then include selecting the lesser of the old solution (τₙ₋₁) at the gridpoint (the old solution at the gridpoint (i, j, k) is denoted as τ_{i,j,k}^{old}) and the calculated solution τ̅ at the gridpoint as the new first traveltime solution for the grid point (denoted as τ_{i,j,k}^{new}), as at 412. Stated in equation form:

η_{i,j,k}^{new}=min(τ_{i,j,k}^{old},τ̅_{i,j,k}) (22)

The method 400 may then set the newly-calculated traveltime solution τ_{i,j,k}^{new} as the old solution τ_{i,j,k}^{old} for the gridpoint, as at 414, for comparison with traveltime solutions τ̅ calculated in subsequent sweeps of the gridpoint. The method 400 may then determine whether to consider another gridpoint in the sweep, as at 416. In some embodiments, the method 400 may include considering one, some, or all of the gridpoints defined in the grid in an individual sweep.

If another gridpoint is to be considered, the method 400 may loop back to 408 and select a next grid point. In an embodiment, the next grid point may be selected at 408 according to the following order:

(1) i=1:I, j=1:J, k=1:K, (2) i=1:I, j=1:J, k=K:1, (3) i=1:I, j=J:1, k=1:K, (4) i=1:I, j=J:1, k=K:1, (5) i=I:1, j=1:J, k=1:K, (6) i=I:1, j=1:J, k=K:1, (7) i=I:1, j=J:1, k=1:K, (8) i=I:1, j=J:1, k=K:1.

Once the gridpoints have been considered, e.g., the determination at 416 is “NO,” the method 400 may include determining whether to conduct another domain sweep, as at 418. If another sweep is to be conducted, the method 400 may again return to selecting a grid point at 408, and considering the grids, e.g., in turn, again. The method 400 may include iterating back and conducting domain sweeps until the values for one, some, or all of the gridpoints converge. Otherwise, the method 400 may end.

FIG. 5 illustrates a flowchart of a sweeping method 500 for determining a traveltime field in a grid representing a domain, according to an embodiment. In some embodiments, the method 500 may be employed as the fast-sweeping eikonal solver at 308 in FIG. 3, e.g., as one embodiment of the sweeping method 400 of FIG. 4.

The method 500 may begin by initiating a new sweep, as at 502. At least for a first sweep, this may include initializing the gridpoints to the initial traveltime value λ as discussed above, and initializing the traveltime at the source gridpoint to zero. The method 500 may then proceed to selecting a gridpoint, as at 504. Selecting the gridpoint at 504 may proceed according to the pattern described above with reference to FIG. 4.

As also mentioned above, the sweeping method 500 may calculate a traveltime value for the gridpoints based upon the traveltimes determined at neighboring gridpoints, in addition to a velocity of the wave in the media. For a given gridpoint with coordinates (i, j, k), “neighboring grid points may be those gridpoints occupying coordinates (i±δ, j±δ, k±δ), where δ may be 1, but might also be one or more other values.

Accordingly, the method 500 may include determining a number of directions in which a neighboring gridpoint has an established traveltime (e.g., is “known” as explained above), as at 506. In a three-dimensional grid, for example, neighboring values may be established in zero, one, two, or three directions.

If no neighboring points have established values, then the number of directions may be zero, as determined at 508. This situation may be common in the initial one or more sweeps for gridpoints away from the source. The method 500 may not change the traveltime value for the gridpoint from λ, thus leaving the gridpoint as having an “unknown” traveltime. The method 500 may return to selecting a next gridpoint, as at 504. Prior to returning to selecting a next gridpoint at 504, the method 500 may include determining whether another gridpoint is to be considered, as at 530, which will be described in greater detail below. However, for ease of illustration, FIG. 5 shows the method 500 returning directly to selecting a next gridpoint at 505.

If one or both neighbors are “known” (e.g., previously calculated) in one direction, as at 510, the method 500 may proceed to solving the first equation (equation (10)) in one dimension to generate the new traveltime solution, as at 512. This may be the case for gridpoints neighboring the source point at the start of the sweep. In subsequent sweeps, this may be the case for gridpoints adjacent to the expanding “box” of calculated traveltimes.

In this case, with one or both neighbors in one direction known, the velocity vectors in the other two directions may be set to zero. For example, if, for a gridpoint (i, j, k), one or both neighbors are known in the x-direction, the velocity vectors v_{gy} and v_{gz} may be set to zero, where v_{gy} and v_{gz} represent the component of group velocity in the y-direction and z-direction, respectively. This yields:

$$\begin{matrix}\frac{\partial H ( x , y , z , {p}_{x} , {p}_{y} , {p}_{z} )}{\partial {p}_{y}} = 0 , \\ and & ( 23 ) \\ \frac{\partial H ( x , y , z , {p}_{x} , {p}_{y} , {p}_{z} )}{\partial {p}_{z}} = 0 , & ( 24 )\end{matrix}$$

In addition, it may be known that

H(x,y,z,pₓ,p_{y},p_{z})=0. (25)

Equations (23)-(25) may thus form a system of three equations, which can be solved for the three slowness vectors pₓ, p_{y}, and p_{z}. Once px is known, the traveltime estimate τₓ for the gridpoint (i, j, k) may be calculated as:

$${p}_{x} = ( \frac{{τ}_{x} - {τ}_{xmin}}{Δ x} ) {s}_{x} ⇒ {τ}_{x} = {τ}_{xmin} + \frac{{p}_{x} Δ x}{{s}_{x}} . \qquad ( 26 )$$

where Δx denotes grid spacing in the x-direction, while sₓ denotes the sign variable as defined by equation (19).

Embodiments in which the neighboring one or more gridpoints in either of the y-direction or z-direction may be similarly calculated. Thus, one-dimensional updates (e.g., as solved at 512) may be calculated, depending on the known direction, as one of:

$$\begin{matrix}{τ}_{x} = {τ}_{xmin} + Δ x \sqrt{\frac{( bc - {f}^{2} ) {f}_{TOR} ( {τ}_{i , j , k} )}{abc - {cd}^{2} - {be}^{2} + 2 def - {af}^{2}}} , & ( 27 ) \\ {τ}_{y} = {τ}_{ymin} + Δ y \sqrt{\frac{( ac - {e}^{2} ) {f}_{TOR} ( {τ}_{i , j , k} )}{abc - {cd}^{2} - {be}^{2} + 2 def - {af}^{2}}} , & ( 28 ) \\ {τ}_{z} = {τ}_{zmin} + Δ z \sqrt{\frac{( ab - {d}^{2} ) {f}_{TOR} ( {τ}_{i , j , k} )}{abc - {cd}^{2} - {be}^{2} + 2 def - {af}^{2}}} , & ( 29 )\end{matrix}$$

where τₓ, τ_{y}, and τ_{z} denote the traveltime update when one or more neighbors in a single direction are known, and the coefficients a, b, c, d, e, and ƒ have the same definition as given in equation (16). Once calculated, the value of the gridpoint may be set as the one-dimensional solution τₓ, τ_{y}, or τ_{z}, as at 514, if the newly-calculated, one-dimensional solution is less than the traveltime value already associated with the gridpoint (which may be the relatively large value λ, if no values have previously been calculated for the gridpoint).

If traveltime values for one or more neighbors in two directions are known (e.g., the values thereof are not λ), as at 516, the method 500 may proceed to solving the first eikonal equation in two-dimensions, as at 518. As with the one-dimensional case, the group velocity vector in the unknown direction may be set to zero. For example, considering a gridpoint (i, j, k) for which one or more neighboring gridpoints have a known value along the x-direction and y-direction, and not the z-direction, v_{gz} may set to zero, where v_{gz} is the component of the group velocity in the z-direction. As such, an underdetermined system of two equations, equations (24) and (25), and three unknowns: pₓ, p_{y}, and p_{z} may be provided. Thus, p_{z} may be solved in terms of pₓ and p_{y}, with the obtained expression being substituted into equation (4) to obtain the equivalent two-dimensional eikonal equation in the x-y plane.

The variables τ_{xy}, τ_{xz}, and τ_{yz} may represent travel estimates that may be computed using neighboring gridpoints in the x-y plane, the x-z plane, and the y-z plane, respectively. The equivalent two dimensional eikonal equation may be obtained by setting the other component of the group velocity (v_{z}) to zero. These equations are:

$$\begin{matrix}( a - \frac{{c}^{2}}{c} ) {( \frac{{τ}_{xy} - {τ}_{xmin}}{Δ x} )}^{2} + 2 ( d - \frac{ef}{c} ) ( \frac{{τ}_{xy} - {τ}_{xmin}}{Δ x} ) ( \frac{{τ}_{xy} - {τ}_{ymin}}{Δ y} ) {s}_{x} {s}_{y} + ( b - \frac{{f}^{2}}{c} ) {( \frac{{τ}_{xy} - {τ}_{ymin}}{Δ y} )}^{2} = {f}_{TOR} ( {τ}_{i , j , k} ) , & ( 30 ) \\ ( a - \frac{{d}^{2}}{b} ) {( \frac{{τ}_{xz} - {τ}_{xmin}}{Δ x} )}^{2} + 2 ( e - \frac{df}{b} ) ( \frac{{τ}_{xz} - {τ}_{xmin}}{Δ x} ) ( \frac{{τ}_{xz} - {τ}_{zmin}}{Δ z} ) {s}_{x} {s}_{z} + ( c - \frac{{f}^{2}}{b} ) {( \frac{{τ}_{xz} - {τ}_{zmin}}{Δ z} )}^{2} = {f}_{TOR} ( {τ}_{i , j , k} ) , & ( 31 ) \\ ( b - \frac{{d}^{2}}{a} ) {( \frac{{τ}_{yz} - {τ}_{ymin}}{Δ y} )}^{2} + 2 ( f - \frac{dc}{a} ) ( \frac{{τ}_{yz} - {τ}_{ymin}}{Δ y} ) ( \frac{{τ}_{yz} - {τ}_{zmin}}{Δ z} ) {s}_{y} {s}_{x} + ( c - \frac{{e}^{2}}{a} ) {( \frac{{τ}_{yz} - {τ}_{zmin}}{Δ z} )}^{2} = {f}_{TOR} ( {τ}_{i , j , k} ) , & ( 32 )\end{matrix}$$

where the coefficients a, b, c, d, e, and ƒ are defined above, and ƒ_{TOR}(τ_{i,j,k}) represents the right hand side of the function, given by equation (9) and evaluated at gridpoint (i, j, k).

Further, the method 500 may include checking for causality, as at 520. In particular, the method 500 may, in an embodiment, include determining whether the condition represented by equation (21) is satisfied. If it is, causality may be concluded, and the method 500 may include using the two-dimensional solution, as at 522, if it is less than the traveltime value already associated with the gridpoint. Otherwise, the method 500 may revert to calculating the one-dimensional solution, as at 514. For example, if the z-direction is unknown, and the x and y directions are known, the method 500 may calculate τ_{xy} using equation (30). Causality may then be checked using equation (21). If the solution fails causality, τ_{xy} and τ_{xy} may be calculated, and the lesser of the two may be selected as the one-dimensional solution for use, as at 514.

If the number of known directions is not zero, one, or two, then one or more neighbors in three directions may be known, and thus the method 500 may proceed to solving the first equation in three dimensions, as at 524. This may commonly be the case in later sweeps. In this case, the first equation (10) may be solved for τ_{xyz} numerically using a quadratic polynomial solver.

As with the two-dimensional solution, the three-dimensional solution may be checked for causality, as at 526, using equation (21). If the solution τ_{xyz} satisfies causality, the method 500 may include using the three-dimensional solution, as at 528, for the selected gridpoint if it is less than the previous traveltime value of the gridpoint. Otherwise, if the solution τ_{xyz} fails causality, the method 500 may revert to determining a two-dimensional solution, as at 518. This may proceed by calculating two-dimensional solutions in the three known directions, yielding traveltime solutions τ_{xy}, τ_{xz}, and τ_{yz}, using equations (30)-(32), respectively, and selecting the minimum as the two-dimensional solution. The method 500 may then also check causality for this two-dimensional solution, as at 520, as described above.

After selecting a one, two, or three-dimensional solution, the method 500 may determine whether to select another gridpoint in the sweep, as at 530. In some embodiments, the method 500 may proceed through one, some, all of the gridpoints. If it is determined to consider another gridpoint, the method 500 may return to block 504 and select a next grid point, e.g., according to the pattern described above. Otherwise, the method 500 may proceed to determining whether to conduct another sweep, as at 530. If another sweep is to be considered, the method 500 may again return to selecting a next gridpoint at 504, which may be the first gridpoint of the new sweep.

The method 500 may provide a solution to the first equation for the selected gridpoint(s). However, to converge to a solution to the full TOR eikonal equation (equation (4)) (or, analogously, the TTI eikonal equation), the method 500 may be iterated two or more times with updated values for the right-hand side of equation (10), ƒ_{TOR}(τₙ₋₁).

Accordingly, referring again to FIG. 3, the method 300 may include multiple iterations of iteratively solving the first equation at 308 and, based on the solution from the first equation, numerically evaluating the second equation at 310, in order to iteratively solve the TTI or TOR eikonal equation. For example, for individual iterations of the loop including blocks 308-312, a new intermediate term ƒ_{TOR}(τₙ) may be provided. The method 300 may then proceed to a next iteration, starting at block 308, with an incremented value of n, such that the ƒ_{TOR}(τₙ) term calculated in the previous iteration becomes ƒ_{TOR}(τₙ₋₁). The traveltime solution may then be recalculated by solving the first equation using the fast-sweeping eikonal solver at 308, based on the updated intermediate term. This may continue until, as mentioned above, it is determined at 312 that the traveltime solution τₙ converges, or there is sufficient information for an extrapolation at 314.

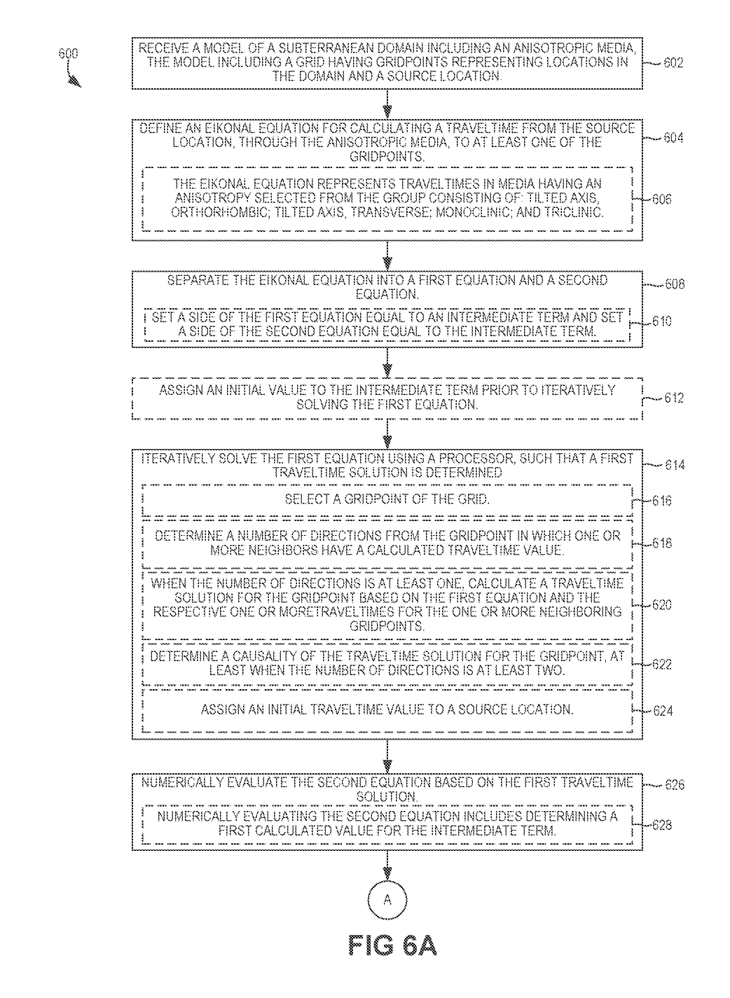

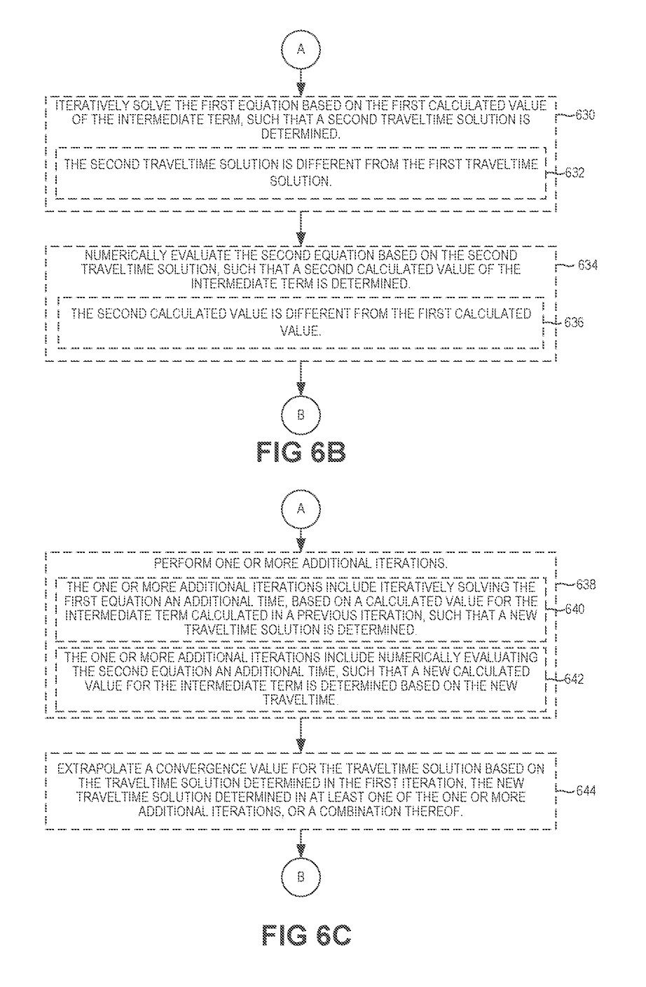

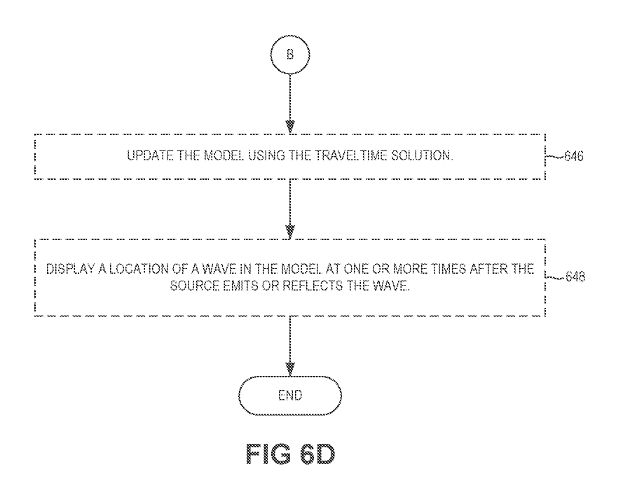

FIG. 6 illustrates a flowchart of a method 600 for calculating traveltime in a model, according to an embodiment. The method 600 may include receiving a model of a subterranean domain including an anisotropic media, with the model including a grid having gridpoints representing locations in the domain and a source location, as at 602 (e.g., FIG. 3, 302, the model including the grid is received as input). Further, the method 600 may include defining an eikonal equation for calculating a traveltime from the source location, through the anisotropic media, to at least one of the gridpoints, as at 604 (e.g., FIG. 3, 303, an eikonal equation is defined). In an embodiment, the eikonal equation represents traveltimes in media having an anisotropy selected from the group consisting of: tilted axis, orthorhombic; tilted axis, transverse, monoclinic, and triclinic, as at 606 (e.g., FIG. 3, 303, the eikonal equation is defined for an anisotropic media, which may be TOR or TTI anisotropic, or have a monoclinic or triclinic anisotropy.).

The method 600 may also include separating the eikonal equation into a first equation and a second equation, as at 608 (e.g., FIG. 3, 304, the eikonal equation is separated into a first equation and a second equation). In an embodiment, separating the eikonal equation includes setting a side of the first equation equal to an intermediate term and setting a side of the second equation equal to the intermediate term, as at 610 (e.g., FIG. 3, 304, the first and second equations are set to equal an intermediate term).

In an embodiment, the method 600 may also include assigning an initial value to the intermediate term, prior to iteratively solving the first equation, as at 612 (e.g., FIG. 3, 306, the intermediate term is initialized to a value, prior to solving the first equation at 308).

The method 600 may further include iteratively solving the first equation, such that a first traveltime solution is determined, as at 614 (e.g., FIG. 3, 308, solving the first equation using a fast-sweeping eikonal solver). In an embodiment, iteratively solving the first equation at 614 may include selecting a gridpoint of the grid, as at 616 (e.g., FIG. 4, 408, selecting a gridpoint). Solving at 614 may also include determining a number of directions from the gridpoint in which one or more neighbors have a calculated traveltime value, as at 618 (e.g., FIG. 5, 506, the number of directions in which neighboring gridpoints have known traveltimes is determined). Solving at 614 may additionally include, when the number of directions is at least one, calculating a traveltime solution for the gridpoint based on the first equation and the traveltimes for the one or more neighboring gridpoints, as at 620 (e.g., FIGS. 5, 512, 518, and 524, the traveltime solution is solved for each case where the number of directions is greater than zero).

In an embodiment, solving at 614 may include determining a causality of the traveltime solution for the gridpoint, at least when the number of directions is at least two (e.g., FIG. 5, 520 and 526, causality is determined when a solution is calculated for two or three directions). In an embodiment, solving at 614 may also include assigning an initial traveltime value to a source location (e.g., FIG. 4, 406, the source location is initialized to a zero traveltime).

The method 600 may also include numerically evaluating the second equation based on the first traveltime solution, as at 626 (e.g., FIG. 3, 310, the second equation is numerically evaluated based on the traveltime solution derived by solving the first equation at 308). In an embodiment, numerically evaluating at 626 may include determining a first calculated value for the intermediate term, as at 628 (e.g., FIG. 3, 310, numerically evaluating the second equation results in a new value for the intermediate term being generated).

In an embodiment, the method 600 may also include iteratively solving the first equation based on the first calculated value of the intermediate term, such that a second traveltime solution is determined, as at 630 (e.g., FIG. 3, 308, in second (and at least some subsequent iterations of the loop 307) the first equation is solved at least partially based on the value of the intermediate term calculated in the previous iteration at 310). Furthermore, the second traveltime solution is different from the first traveltime solution, as indicated at 632 (e.g., FIG. 3, 308, the traveltimes may proceed toward a convergence value but may not be the same as between separate iterations).

In an embodiment, the method 600 may further include numerically evaluating the second equation based on the second traveltime solution, such that a second calculated value of the intermediate term is determined, as at 634 (e.g., FIG. 3, 310, the second equation is evaluated based on the traveltime solution calculated by solving the first equation within the loop 307). In an embodiment, the second calculated value is different from the first calculated value, as indicated at 636 (e.g., FIG. 3, 310, the intermediate term values may be different as between different iterations of the loop 307).

In an embodiment, iteratively solving the first equation and numerically evaluating the second equation are performed in a first iteration (e.g., FIGS. 3, 308 and 310, the solving and evaluating may be iterative). In such an embodiment, the method 600 may further include performing one or more additional iterations, as at 638. In such additional iterations, the method 600 may include iteratively solving the first equation an additional time, based on a calculated value for the intermediate term calculated in a previous iteration, such that a new traveltime solution is determined, as at 640. The method 600 may also include numerically evaluating the second equation an additional time, such that a new calculated value for the intermediate term is determined based on the new traveltime.

In an embodiment, the method 600 may also include extrapolating a convergence value for the traveltime solution based on the traveltime solution determined in the first iteration, the new traveltime solution determined in at least one of the one or more additional iterations, or a combination thereof, as at 644 (e.g., FIG. 3, 314, extrapolating the solution at convergence, e.g., using the Aitken extrapolation, to increase the convergence rate).

In an embodiment, the method 600 may also include updating the model using the traveltime solution, as at 646 (e.g., FIG. 1, 110, the model is updated based on the traveltime solution). The method 600 may further include displaying a location of a wave in the model at one or more times after the source emits or reflects the wave, as at 648 (e.g., FIG. 1, 112, a snapshot of the model at a point in time, showing the wave front location, may be displayed).

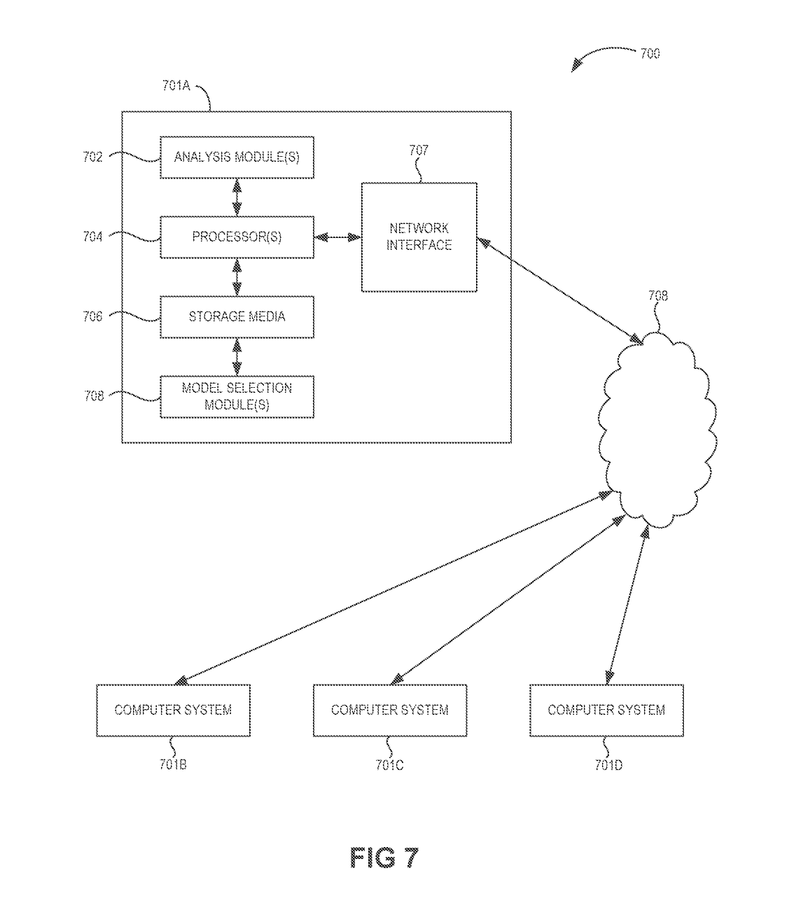

In some embodiments, the methods 100 and 300-600 may be executed by a computing system. FIG. 7 illustrates an example of such a computing system 700, in accordance with some embodiments. The computing system 700 may include a computer or computer system 701A, which may be an individual computer system 701A or an arrangement of distributed computer systems. The computer system 701A includes one or more analysis modules 702 that are configured to perform various tasks according to some embodiments, such as one or more methods disclosed herein (e.g., methods 100 and 300-600, and/or combinations and/or variations thereof). To perform these various tasks, the analysis module 702 executes independently, or in coordination with, one or more processors 704, which is (or are) connected to one or more storage media 706A. The processor(s) 704 is (or are) also connected to a network interface 707 to allow the computer system 701A to communicate over a data network 708 with one or more additional computer systems and/or computing systems, such as 701B, 701C, and/or 701D (note that computer systems 701B, 701C and/or 701D may or may not share the same architecture as computer system 701A, and may be located in different physical locations, e.g., computer systems 701A and 701B may be located in a processing facility, while in communication with one or more computer systems such as 701C and/or 701D that are located in one or more data centers, and/or located in varying countries on different continents).

A processor can include a microprocessor, microcontroller, processor module or subsystem, programmable integrated circuit, programmable gate array, or another control or computing device.

The storage media 706A can be implemented as one or more computer-readable or machine-readable storage media. Note that while in the example embodiment of FIG. 7 storage media 706A is depicted as within computer system 701A, in some embodiments, storage media 706A may be distributed within and/or across multiple internal and/or external enclosures of computing system 701A and/or additional computing systems. Storage media 706A may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY® disks, or other types of optical storage, or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In some embodiments, computing system 700 contains one or more completion quality determination module(s) 708. In the example of computing system 700, computer system 701A includes the completion quality determination module 708. In some embodiments, a single completion quality determination module may be used to perform some or all aspects of one or more embodiments of the methods 100 and 300-600. In alternate embodiments, a plurality of completion quality determination modules may be used to perform some or all aspects of methods 100 and 300-600.

It should be appreciated that computing system 700 is only one example of a computing system, and that computing system 700 may have more or fewer components than shown, may combine additional components not depicted in the example embodiment of FIG. 7, and/or computing system 700 may have a different configuration or arrangement of the components depicted in FIG. 7. The various components shown in FIG. 7 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

It is important to recognize that geologic interpretations, models and/or other interpretation aids may be refined in an iterative fashion; this concept is applicable to methods 100 and 300-600 as discussed herein. This can include use of feedback loops executed on an algorithmic basis, such as at a computing device (e.g., computing system 700, FIG. 7), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. Moreover, the order in which the elements of the methods 100 and 300-600 are illustrate and described may be re-arranged, and/or two or more elements may occur simultaneously. The embodiments were chosen and described in order to best explain the principals of the invention and its practical applications, to thereby enable others skilled in the art to best utilize the invention and various embodiments with various modifications as are suited to the particular use contemplated.

What is claimed is:

1. A method for calculating traveltime in a model, comprising:
receiving a model of a subterranean domain comprising an anisotropic media, the model comprising a grid having gridpoints representing locations in the domain and a source location;
defining an eikonal equation for calculating a traveltime from the source location, through the anisotropic media, to at least one of the gridpoints;
separating the eikonal equation into a first equation and a second equation;
iteratively solving the first equation using a processor, such that a first traveltime solution is determined; and
numerically evaluating the second equation based on the first traveltime solution.

2. The method of claim 1, wherein separating the eikonal equation into a first equation and a second equation comprises setting a side of the first equation equal to an intermediate term and setting a side of the second equation equal to the intermediate term.

3. The method of claim 2, further comprising assigning an initial value to the intermediate term prior to iteratively solving the first equation.

4. The method of claim 3, wherein numerically evaluating the second equation comprises determining a first calculated value for the intermediate term.

5. The method of claim 4, further comprising iteratively solving the first equation based on the first calculated value of the intermediate term, such that a second traveltime solution is determined, wherein the second traveltime solution is different from the first traveltime solution.

6. The method of claim 5, further comprising numerically evaluating the second equation based on the second traveltime solution, such that a second calculated value of the intermediate term is determined.

7. The method of claim 2, wherein iteratively solving the first equation and numerically evaluating the second equation are performed in a first iteration, the method further comprising:
performing one or more additional iterations comprising:
iteratively solving the first equation an additional time, based on a calculated value for the intermediate term calculated in a previous iteration, such that a new traveltime solution is determined; and
numerically evaluating the second equation an additional time, such that a new calculated value for the intermediate term is determined based on the new traveltime.

8. The method of claim 7, further comprising extrapolating a convergence value for the traveltime solution based on the traveltime solution determined in the first iteration, the new traveltime solution determined in at least one of the one or more additional iterations, or a combination thereof.

9. The method of claim 1, wherein iteratively solving the first equation comprises:
selecting a gridpoint of the grid;
determining a number of directions from the gridpoint in which one or more neighbors have a calculated traveltime value; and
when the number of directions is at least one, calculating a traveltime solution for the gridpoint based on the first equation and the traveltimes for the one or more neighboring gridpoints.

10. The method of claim 9, wherein iteratively solving the first equation further comprises determining a causality of the traveltime solution for the gridpoint, at least when the number of directions is at least two.

11. The method of claim 9, wherein iteratively solving the first equation comprises assigning an initial traveltime value to the source location.

12. The method of claim 1, wherein the eikonal equation represents traveltimes in media having an anisotropy selected from the group consisting of: tilted axis, orthorhombic; tilted axis, transverse; monoclinic; and triclinic.

13. The method of claim 1, further comprising:
updating the model using the traveltime solution; and
displaying a location of a wave in the model at one or more times after the source emits or reflects the wave.

14. A computing system, comprising:
one or more processors; and
a memory system comprising one or more non-transitory, computer-readable media comprising instructions that, when executed by at least one of the one or more processors, cause the computing system to perform operations, the operations comprising:
receiving a model of a subterranean domain comprising an anisotropic media, the model comprising a grid having gridpoints representing locations in the domain and a source location;
defining an eikonal equation for calculating a traveltime from the source location, through the anisotropic media, to at least one of the gridpoints;
separating the eikonal equation into a first equation and a second equation;
iteratively solving the first equation, such that a first traveltime solution is determined; and
numerically evaluating the second equation based on the first traveltime solution.

15. The system of claim 14, wherein separating the eikonal equation into a first equation and a second equation comprises setting a side of the first equation equal to an intermediate term and setting a side of the second equation equal to the intermediate term.

16. The system of claim 15, further comprising assigning an initial value to the intermediate term prior to iteratively solving the first equation.

17. The system of claim 16, wherein numerically evaluating the second equation comprises determining a first calculated value for the intermediate term.

18. The system of claim 17, further comprising iteratively solving the first equation based on the first calculated value of the intermediate term, such that a second traveltime solution is determined, wherein the second traveltime solution is different from the first traveltime solution.

19. The system of claim 18, wherein the operations further comprise numerically evaluating the second equation based on the second traveltime solution, such that a second calculated value of the intermediate term is determined.

20. The system of claim 15, wherein iteratively solving the first equation and numerically evaluating the second equation are performed in a first iteration, the operations further comprising:
performing one or more additional iterations comprising:
iteratively solving the first equation an additional time, based on a calculated value for the intermediate term calculated in a previous iteration, such that a new traveltime solution is determined; and
numerically evaluating the second equation an additional time, such that a new calculated value for the intermediate term is determined based on the new traveltime.
